(19) United States
(12) Patent Application Publication
(10) Pub. No.: US 2005/0126058 A1
(43) Pub. Date: Jun. 16, 2005

(54) Grave marker with memorabilia compartment

(76) Inventors: Ilija Rojdev, Loveland, OH (US); Sam Ruffner, Columbus, GA (US)

Correspondence Address: WOOD, HERRON & EVANS, LLP, 2700 CAREW TOWER, 441 VINE STREET, CINCINNATI, OH, 45202, US

(21) Appl. No.: 10/734,683

(22) Filed: Dec. 12, 2003

(51) Int. Cl. G09F 19/00

(52) U.S. Cl. 40/124.5

(57) ABSTRACT

A grave marker memorabilia compartment assembly adapted to couple to a grave marker to provide display and storage for mementos and other items of memorabilia pertaining to the deceased comprises a grave marker plate, a retainer coupled to an underside of the grave marker plate for retaining the mementos and other items of memorabilia and a retainer door formed in the grave marker plate that covers the retainer when the retainer door is in a closed position and further allows the contents of the retainer to be viewed when the retainer door is in an open position.

### FIELD OF THE INVENTION

This invention relates generally to burial or grave markers, and more particularly to grave markers with a compartment containing memorabilia relating to the deceased.

### BACKGROUND OF THE INVENTION

Grave markers are well known in the art and typically take the form of a headstone made of marble, granite or other type of stone or suitable structural material. The grave marker usually includes certain information such as, for example, the deceased's name, dates of birth and death as well as an epitaph or other thoughtful sentiment.

Oftentimes, there is a desire on the part of the deceased's family and loved ones to memorialize or “stay in touch” with the faithfully departed. This may manifest itself in several ways such as, for example, keeping various sentimental items close to the burial site. The placement of various items of personalty at grave sites, such as flowers, jewelry, photographs and other mementos, has existed as a means of staying in touch with the deceased. These items of personalty are usually placed on the ground adjacent to the headstone and may created various problems with cemetery maintenance such as cutting the grass and keeping the cemetery clean of debris.

There are a number of devices in the prior art for storing memorabilia near a grave site. The provision for memorabilia storage near a grave site is meaningful, because it gives many people peace of mind prior to death by knowing that they will still be in close proximity to objects that have sentimental value. Providing a memorabilia storage compartment that is viewable by visitors of a grave site is also important because it provides the visitor a sense of staying in touch with the decedent by viewing memorabilia stored therein. In this way, survivors can be reminded of and memorialize major events with the deceased by placing pictures and other memorabilia in the storage compartment.

For instance, U.S. Pat. No. 5,729,921 discloses a grave marker having a memorabilia compartment therein that is accessible to visitors to the grave site. The marker is a box interred in the ground and is made from a plastic material that is lightweight and easy to mold. The box houses an air and water tight cylindrical container in which memorabilia is placed and retained. A removable lid covers the top surface of the box and provides additional protection for the memorabilia from the elements. U.S. Pat. No. 6,463,703 also discloses a burial marker having a cylindrical or rectangular memorabilia storage compartment. The memorabilia storage compartment is formed directly in a solid construction marker and includes a lid that seals the contents of the compartment from the air and water.

Advances have therefore been made in the area of grave marker memorabilia storage compartments as demonstrated with the products discussed above. However, there continues to be room for improvement in the area of grave markers with memorability storage.

### SUMMARY OF THE INVENTION

The present invention is a grave marker memorabilia compartment assembly adapted to couple to a grave marker to provide display and storage for mementos and other items of memorabilia pertaining to the deceased. The memorabilia compartment assembly comprises a grave marker plate, a retainer coupled to an underside of the grave marker plate for retaining the mementos and other items of memorabilia, and a retainer door formed in the grave marker plate that covers the retainer when the retainer door is in a closed position and further allows the contents of the retainer to be viewed when the retainer door is in an open position.

The grave marker plate can be generally rectangular having a pair of opposed sides extending in a longitudinal direction and a pair of opposed sides extending in a traverse direction. The retainer can be generally rectangular having a bottom wall and four side walls and defining an opening along a top end of the side walls having a pair of opposed longer sides extending in the longitudinal direction and a pair of opposed shorter sides extending in the traverse direction. A transparent member can be sandwiched between the retainer and underside of the grave marker plate. Moreover, a sealing gasket can be sandwiched between the transparent member and the underside of the plate such that the retainer, transparent member and sealing gasket can be securely coupled to the grave marker plate to provide an airtight and watertight memorabilia compartment.

The retainer door of the memorabilia compartment assembly provides visual access to the contents of the memorabilia compartment. The retainer door can be generally rectangular with a pair of opposed longer sides extending in the longitudinal direction and a pair of opposed shorter sides extending in the traverse direction. The retainer door can be hinged to the grave marker plate to provide an open and closed position. When the retainer door is in the open position, the contents of the memorabilia compartment can be viewed. When the retainer door is in the closed position, the top surface of the retainer door comprises at least a portion of the top surface of the grave marker plate and as such can include an inscription as a part of, for example, identifying the deceased. The retainer door and/or grave marker plate can include a latch for securing the retainer door in the closed position.

The memorabilia compartment assembly can further include a flower-receptacle and/or a candle receptacle. Both receptacles comprise a door formed in the grave marker plate that can, for example, be hingably attached to the plate to provide an open and closed position. The door includes a tube coupled to the underside of the door and having an axis along the length of the tube such that the axis is in a substantially vertical orientation when the door is in the open position. The tubes are adapted to receive flowers or a candle. In this way, flowers and a candle can be displayed at the grave site to memorialize the deceased.

In another aspect, a grave marker having a memorabilia compartment for mementos and other items of memorabilia comprises a generally rectangular base for interment into the ground and having a recess formed in a top surface thereof and a grave marker memorabilia compartment assembly coupled to the base. The memorabilia compartment assembly comprises a grave marker plate, a retainer coupled to an underside of the grave marker plate for retaining the mementos and other items of memorabilia and a retainer door formed in the grave marker plate having an open and closed position, the mementos and other items of memorabilia-viewable when the retainer door is in the open position. The retainer is positioned in the recess of the base when the grave marker memorabilia compartment assembly is coupled to the base.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of a grave marker having a memorabilia compartment assembly for storing mementos and other items of memorabilia in accordance with the principles of the present invention;

FIG. 2 is a perspective view of the grave marker memorabilia compartment assembly of FIG. 1;

FIG. 3 is a cross sectional view of the grave marker of FIG. 5 taken generally along line 3-3.

FIG. 4 is an enlarged disassembled cross sectional view of the retainer of FIG. 3 but showing the retainer door in a closed position.

FIG. 5 is a perspective view of a grave marker similar to FIG. 1 but showing the retainer door, flower receptacle door and the candle receptacle door all in the open position.

### DETAILED DESCRIPTION OF A PREFERRED EMBODIMENT OF THE INVENTION

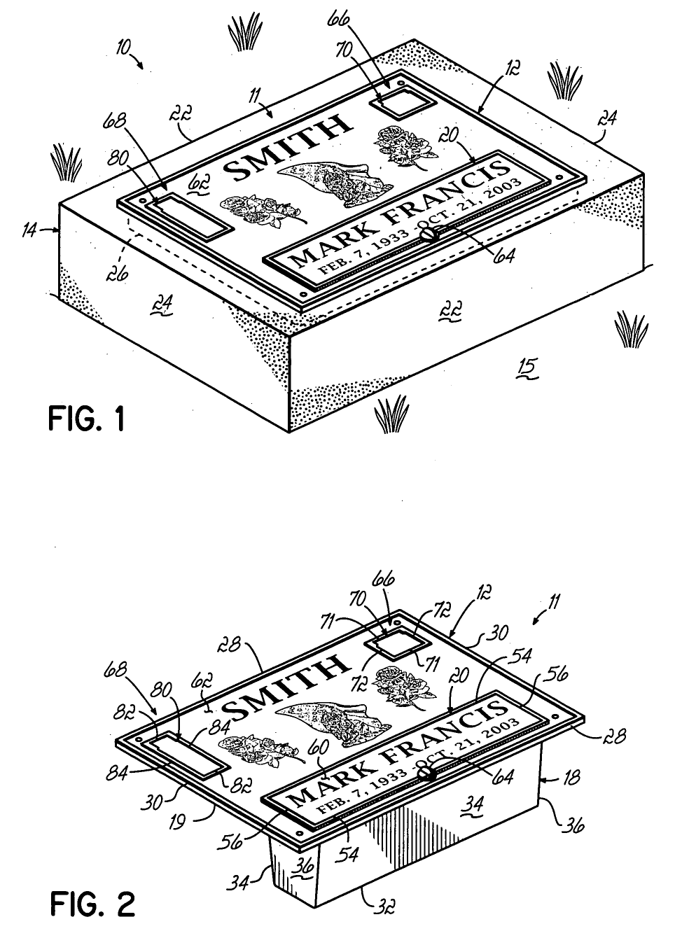

With reference to FIG. 1, there is illustrated a grave marker 10 incorporating a grave marker memorabilia compartment assembly 11 according to the present invention. The grave marker 10 includes a base 14 generally interred into the ground 15 and a memorabilia compartment assembly 11 typically overlying a portion of, and removably coupled to, a top surface 16 of grave marker base 14 by means known to those having skill in the art.

Referring now to FIGS. 1-4, the memorabilia compartment assembly 11 of the present invention comprises a grave marker plate 12, a retainer 18 coupled to the underside surface 19 of the grave marker plate 12 and a retainer door 20 formed from a portion of grave marker plate 12. Grave marker plate 12 traditionally includes certain information about the deceased, such as, for example, the deceased's name, dates of birth and death, and perhaps an epitaph or decorative design. Mementos and other items of memorabilia pertinent to the deceased can be placed in the retainer 18. Retainer door 20 has a closed position such that retainer door 20 covers retainer 18 when in the closed position and an open position such that the contents of retainer 18 can be viewed when in the open, position.

Grave marker base 14 is interred in ground 15 and can be generally rectangular having a pair of opposed sides 22, 22 extending in a longitudinal direction and a pair of opposed sides 24, 24 extending in a traverse direction. The grave marker base 14 can be made of a marble, granite, concrete, or any other type of stone or suitable material known in the art. Base 14 can include a recess 26 formed therein to accommodate retainer 18 when grave marker memorabilia compartment assembly 11 is removably coupled to the top surface 16 of base 14. Recess 26 can for example be a hole extending through base 14 such that retainer 18 is unsupported by base 14 or alternatively, recess 26 can be formed in base 14 so as to conform to the shape of retainer 18 and support retainer 18 when memorabilia compartment assembly 11 is coupled to base 14.

Grave marker plate 12 can be generally rectangular having a pair of opposed sides 28, 28 extending in the longitudinal direction and a pair of opposed sides 30, 30 extending in the traverse direction and corresponding to sides 22,.22 and 24, 24 of base 14, respectively. Grave marker plate 12 can be made of a bronze, an aluminum, a composite material, including plastic, or any other suitable material known in the art. Retainer 18 can be coupled to the underside surface 19 of plate 12 by known means, such as, for example, a plurality of threaded bolts and corresponding tapped holes in grave marker plate 12.

As illustrated in FIGS. 2-4, retainer 18 can be generally rectangular including a bottom wall 32, and pair of longer side walls 34 and a pair of shorter side walls 36 to define an opening 38 at the top end 40 of retainer 18. When retainer 18 is coupled to the grave marker plate, longer side walls 34 extend in the longitudinal direction while shorter side walls 36 extend in the traverse direction. It is to be understood, however, that the invention is not so limited to the rectangular configuration described herein and those skilled in the art will recognize many possible configurations. Side walls 34, 36 can further include an outwardly extending lip 42 along opening 38 such that retainer 18 is secured to the underside surface 19 of grave marker plate 12 by, for example, a plurality of threaded bolts and corresponding tapped holes in grave marker plate 12, along lip 42. Retainer 18 can be made from a composite material, such as plastic, a metal, such as sheet metal, or any other suitable material known in the art.

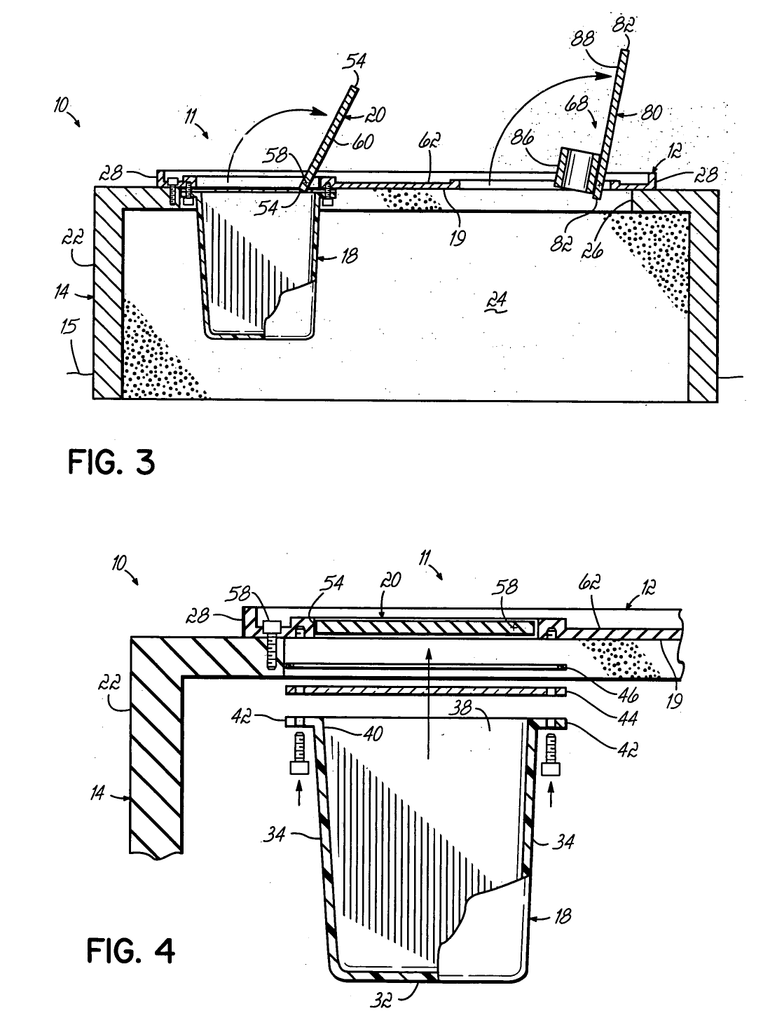

As shown in FIGS. 3 and 4, to protect items placed in the retainer 18 from theft and environmental deterioration, memorabilia compartment assembly 11 can further include a transparent member 44 juxtaposed or sandwiched between retainer 18 and the underside surface 19 of grave marker plate 12. When memorabilia compartment assembly 11, including transparent member 44, is installed and coupled to grave marker base 14 (FIG. 1), the contents of retainer 18 are no longer accessible (i.e., without disassembly), but can still be viewed by the deceased's family and loved ones through retainer door 20. In this way, the contents of retainer 18 can have increased safety from vandals and the like while providing a location for mementos and other items of memorabilia that have particular meaning to the deceases or to his/her family. The transparent member can be made from a tempered glass, plexiglass, lexan, or other suitable materials, such as other polycarbonate materials.

Furthermore, the grave market memorabilia compartment assembly 11 can also include a sealing gasket 46 sandwiched between the transparent member 44 and the underside surface 19 of grave marker plate 12. The sealing gasket 46 can be configured to prevent any water and/or air from entering retainer 18 and deteriorating items placed therein. The sealing gasket 46 can for example, be a gasket ring and the underside surface 19 of plate 12 can further include a groove to properly position the gasket ring.

The grave marker plate 12 includes retainer door 20 that provides at least visual access to the items in retainer 18. Retainer door 20 generally conforms and can be coextensive with opening 38 in retainer 18. Retainer door 20 can be rectangular having a pair of opposed longer sides 54 and a pair of opposed shorter sides 56. Longer sides 54 extend in the longitudinal direction and shorter sides 56 extend in the transverse direction with retainer door 20 overlying opening 38 of retainer 18. Retainer door 20 can include a hinge 58 that permits retainer-door 20 to pivot about, for example, a longitudinal axis. When retainer-door 20 is in an open position, the contents of retainer 20 can be readily viewed. When retainer door 20 is in a closed position, a top surface 60 of retainer door 20 comprises at least a portion of a top surface 62 of grave market plate 12 and thus can include an inscription, such as the deceased's name, or other design that can be incorporated into the overall design of grave marker plate 12. Retainer door 20 and/or top surface 62 of grave marker plate 12 can also include a latch or locking mechanism 64 for securing retainer door 20 in the closed position.

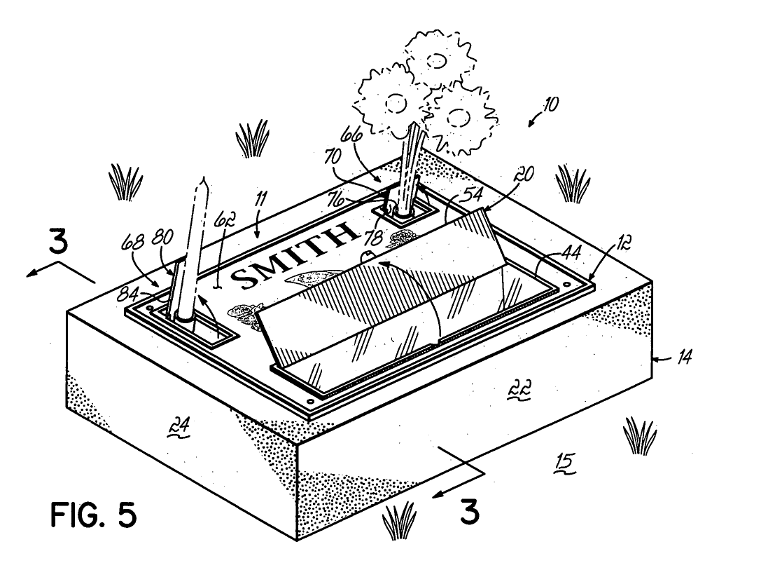

As shown in FIG. 5, grave marker memorabilia compartment assembly 11 can also include a flower receptacle 66 and/or a candle receptacle 68. Flower receptacle 66 can include a flower receptacle door 70 formed in grave marker plate 12 and having a pair of opposed sides 71, 71 extending in the longitudinal direction and a pair of opposed sides 72, 72 extending in the traverse direction. Flower receptacle door 70 can be hingably attached to grave marker plate 12 so as to pivot about, for example, a longitudinal axis thereby providing an open and closed position. Flower receptacle door 70 can further include a cylindrical tube 76 coupled to the underside surface 78 of flower receptacle door 70 and configured such that an axis extending through tube 76 can be in a substantially vertical orientation when flower receptacle door 70 is in the open position. When flower receptacle door 70 is in the open position, tube 76 can be adapted to receive one or more flowers (shown in phantom) to memorialize the deceased.

Candle receptacle 68 can include a candle receptacle door 80 formed in grave marker plate 12 and having a pair of opposed sides 82, 82 extending in the longitudinal direction and a pair of opposed sides 84, 84 extending in the traverse direction. Candle receptacle door 80 can be hingably attached to grave marker plate 12 so as to pivot about, for example, a longitudinal axis thereby providing an open and closed position. Candle receptacle door 80 can further includes a cylindrical tube 86 coupled to the underside surface 88 of candle receptacle door 80 and configured such that an axis extending through tube 86 can be in a substantially vertical orientation when candle receptacle door 80 is in the open position. When candle receptacle door 80 is in the open position, tube 86 can be adapted to receive a candle (shown in phantom) to memorialize the deceased.

Those skilled in the art will readily recognize numerous adaptations and modifications which can be made to the present invention which will result in an improved grave marker with memorabilia compartment, yet all of which will fall within the spirit and scope of the present invention as defined in the following claims. Accordingly, the invention is to be limited only by the scope of the following claims and their equivalents.

1. A grave marker memorabilia compartment assembly adapted to couple to a grave marker and to provide display and storage for mementos and other items of memorabilia, said grave marker memorabilia compartment assembly comprising:
a grave marker plate;
a retainer coupled to an underside of said grave marker plate for retaining the mementos and other items of memorabilia; and
a retainer door formed in said grave marker,plate having an open and closed position, the mementos and other items of memorabilia viewable when said retainer door is in the open position.

2. The assembly of claim 1 further comprising a transparent member juxtaposed between said retainer and said underside of said grave marker plate.

3. The assembly of claim 2 further comprising a sealing gasket juxtaposed between said transparent member and said underside of said grave marker plate to form an airtight and watertight seal.

4. The assembly of claim 1 wherein said grave marker plate is generally rectangular having a pair of sides extending in a longitudinal direction and a pair of sides extending in a traverse direction.

5. The assembly of claim 1 wherein said retainer comprises a bottom wall and at least one side wall defining an opening at a top end thereof, said at least one side wall having an outwardly extending lip adjacent said opening, said retainer coupling to said underside of said grave marker plate along said lip.

6. The assembly of claim 1 wherein said retainer door is generally rectangular having a longer pair of sides extending in a longitudinal direction and a shorter pair of sides extending in a traverse direction.

7. The assembly of claim 1 wherein said retainer door is hinged to said grave marker plate.

8. The assembly of claim 1 wherein said retainer door has a top surface forming at least a portion of a top surface of said grave marker plate when in the closed position, said retainer door top surface including an inscription therein.

9. The assembly of claim 1 wherein at least one of said retainer door and said grave marker plate further comprises a latch for securing said retainer door in the closed position.

10. The assembly of claim 1 further comprising a flower receptacle comprising:
a flower receptacle door formed in said grave marker plate and having an open and closed position; and
a tube coupled to an underside of said flower receptacle door, said tube having an axis along a length of said tube, the axis being in a substantially vertical orientation when said flower receptacle door is in the open position, said tube adapted to receive flowers when said flower receptacle door is in the open position.

11. The assembly of claim 1 further comprising a candle receptacle comprising:
a candle receptacle door formed in said grave marker plate and having an open and closed position; and
a tube coupled to an underside of said candle receptacle door, said tube having an axis along a length of said tube, the axis being in a substantially vertical orientation when said candle receptacle door is in the open position, said tube adapted to receive a candle when said candle receptacle door is in the open position.

12. The assembly of claim 1 wherein said grave marker plate is made from at least one of a bronze, an aluminum, and a composite material.

13. The assembly of claim 1 wherein said retainer is made from at least one of a composite material and a metal.

14. The assembly of claim 2 wherein said transparent member is made from at least one of a tempered glass, plexiglass, and lexan.

15. A grave marker having a memorabilia compartment for mementos and other items of memorabilia comprising:
a generally rectangular base for interment into the ground and having a recess formed in a top surface thereof; and,
a grave marker memorabilia compartment assembly coupled to said base, said memorabilia compartment assembly comprising:
a grave marker plate;
a retainer coupled to an underside of said grave marker plate for retaining the mementos and other items of memorabilia; and
a retainer door formed in said grave marker plate having an open and closed position, the mementos and other items of memorabilia viewable when said retainer door is in the open position;
said retainer being positioned in said recess of said base when said grave marker memorabilia compartment assembly is coupled to said base.

16. The grave marker of claim 15 further comprising a transparent member juxtaposed between said retainer and said underside of said grave marker plate.

17. The grave marker of claim 16 further comprising a sealing gasket juxtaposed between said transparent member and said underside of said grave marker plate to form an airtight and watertight seal.

18. The grave marker of claim 15 wherein said grave marker plate is generally rectangular having a pair of sides extending in a longitudinal direction and a pair of sides extending in a traverse direction.

19. The grave marker of claim 15 wherein said retainer comprises a bottom wall and four side walls defining an opening at a top end, said side walls having an outwardly extending lip adjacent said opening, said retainer coupling to said underside of said grave marker plate along said lip.

20. The grave marker of claim 15 wherein said retainer door is generally rectangular having a longer pair of sides extending in a longitudinal direction and a shorter pair of sides extending in a traverse direction.

21. The grave marker of claim 15 wherein said retainer door is hinged to said grave marker plate.

22. The grave marker of claim 15 wherein said retainer door has a top surface forming at least a portion of a top surface of said grave marker plate when in the closed position,'said retainer door top surface including an inscription therein.

23. The grave marker of claim 15 wherein at least one of said retainer door and said grave marker plate further comprises a latch for securing said retainer door in the closed position.

24. The grave marker of claim 15 further comprising a flower receptacle comprising:
a flower receptacle door formed in said grave marker plate and having an open and closed position; and
a tube coupled to an underside of said flower receptacle door, said tube having an axis along a length of said tube, the axis being in a substantially vertical orientation when said flower receptacle door is in the open position, said tube adapted to receive flowers when said flower receptacle door is in the open position.

25. The grave marker plate of claim 15 further comprising a candle receptacle comprising:
a candle receptacle door formed in said grave marker plate and having an open and closed position; and
a tube coupled to an underside of said candle receptacle door, said tube having an axis along a length of said tube, the axis being in a substantially vertical orientation when said candle receptacle door is in the open position, said tube adapted to receive a candle when said candle receptacle door is in the open position.

26. The grave marker of claim 15 wherein said recess in said base is a hole extending through said base.

27. The grave marker of claim 15 wherein said grave marker plate is made from at least one, of a bronze, an aluminum, and a composite material.

28. The grave marker of claim 15 wherein said retainer is made from at least one of a composite material and a metal.

29. The grave marker of claim 16 wherein said transparent member is made from at least one of a tempered glass, plexiglass, and lexan.

30. The grave marker of claim 15 wherein said base is made from at least one of a granite, marble, and concrete.
